(19) United States
(12) Patent Application Publication
(10) Pub. No.: US 2005/0094635 A1
(43) Pub. Date: May 5, 2005

(54) Ethernet SCSI simulator for control of shows

(76) Inventor: Mark A. Hunt, Derby (GB)

Correspondence Address: FISH & RICHARDSON, PC, 12390 EL CAMINO REAL, SAN DIEGO, CA, 92130-2081, US

(21) Appl. No.: 10/913,294

(22) Filed: Aug. 5, 2004

Related U.S. Application Data
(60) Provisional application No. 60/493,864, filed on Aug. 8, 2003.

(51) Int. Cl. H04L 12/56

(52) U.S. Cl. 370/389

(57) ABSTRACT

A lighting system which allows packaging data in a first format into an ethernet packet. The data is packaged within the ethernet packet, in a way so that it can be removed and placed back into its original format. This allows ethernet hardware to be used, with existing lighting hardware.

### CROSS-REFERENCE TO RELATED APPLICATION

This application claims benefit of the priority of U.S. Provisional Application Ser. No. 60/493,864 filed Aug. 8, 2003 and entitled “Ethernet SCSI Simulator for Control of Shows”.

### BACKGROUND

The ICON system made by Light and Sound Design has typically used the architecture shown in FIG. 1. An ICON console is used to control each of a number of different output lights. For example, there may be 256 or more lights that can be controlled using the ICON console. In the usual control system, the ICON console produced its output using either SCSI protocol or ultrawide SCSI protocol. This SCSI output sent controls for all of the lights e.g. 256 lights, to the distribution unit 110. Distribution unit 110 decoded the SCSI output and produced separate light outputs, for example, a separate output 112 for light 114, a separate output 116 for light 118, and the like.

SCSI parts have become less common, and more recently, it has become desirable to use Ethernet for lighting control. However, there is an installed base of these hardware devices.

### SUMMARY

The present system describes a device which converts Ethernet protocol representing commands for plural lights, into single channel per output line protocol for lights. In an embodiment, the conversion effectively simulates the SCSI process, enabling operation with a minimal amount of change of hardware.

### BRIEF DESCRIPTION OF THE DRAWINGS

These and other aspects will now be described in detail with reference to the accompanying drawings, wherein:

FIG. 1 shows a basic layout of the hardware systems;

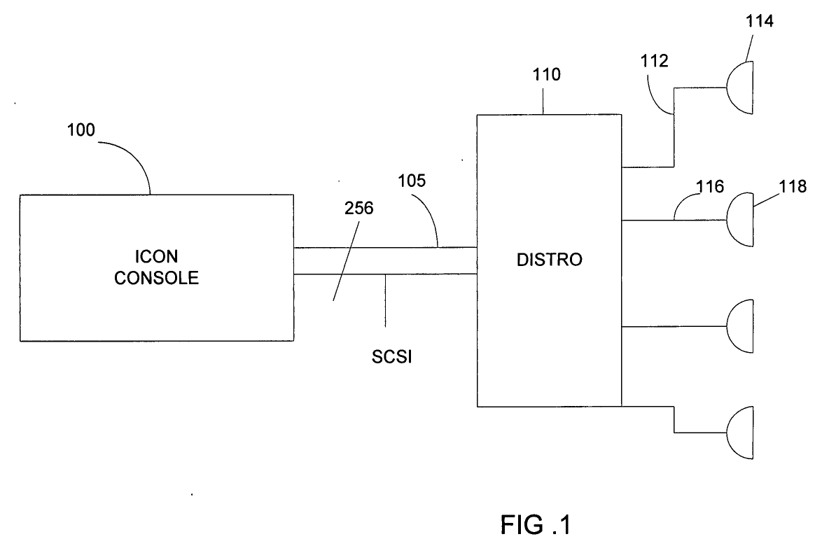

FIG. 2 shows connecting a consul to distribution unit;

FIG. 3 shows the layout of the ethernet protocol as used in this system;

FIG. 4 shows a flowchart of operation of the processor.

FIG. 5 shows a layout of the format of the DMX format.

### DETAILED DESCRIPTION

In the embodiment, the ICON console 200 produces outputs in ethernet protocol. However, since the ethernet protocol may be limited to 1500 bytes, control of a number of lights may require multiple separate ethernet signals as shown. In one embodiment, 10 channels of ICON data can be provided in one ethernet packet.

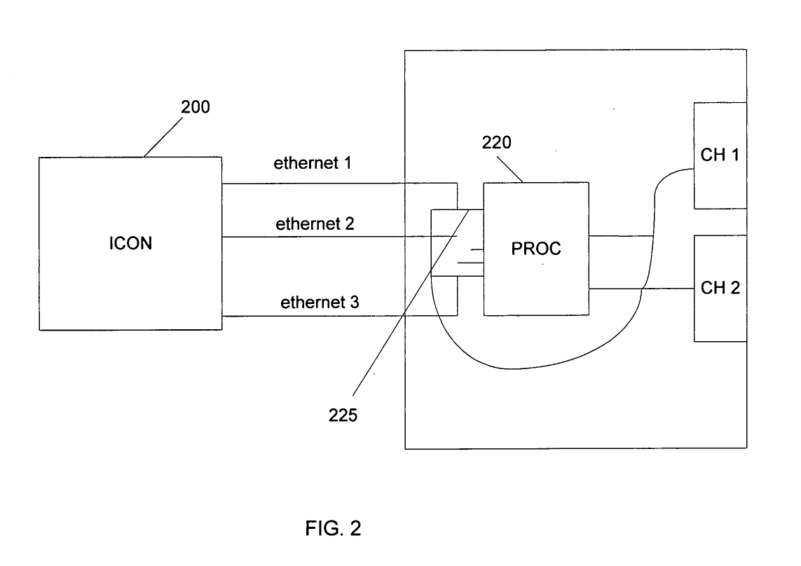

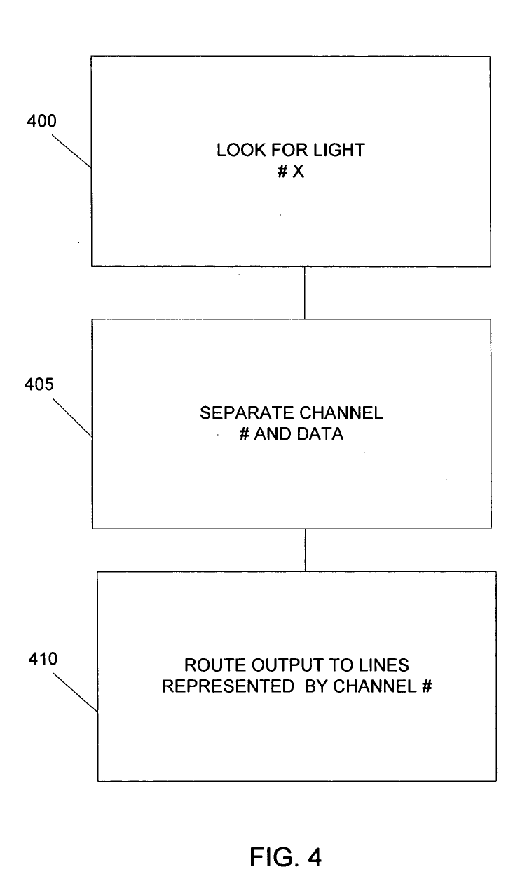

FIG. 2 shows three ethernet cables being run although it should be understood that any number of such wires may need to be run. The ethernet cables are sent to the distribution unit 220 which includes an ethernet interface 225 managed by a processor 230. A processor also runs the flowchart shown in FIG. 4. The processor may be the same processor, or processor 230 may be a dedicated network processor.

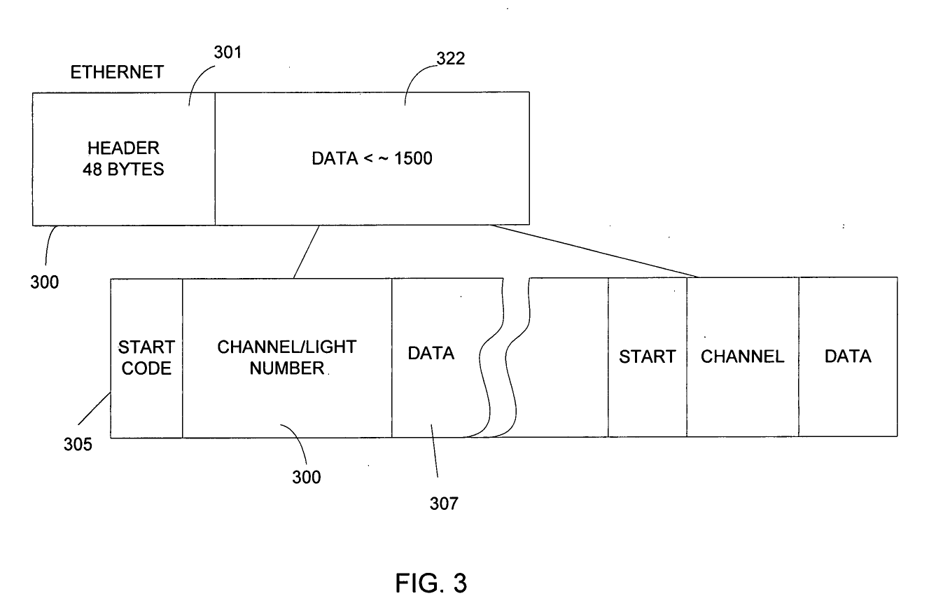

At 400, the processor chooses a light number “X”, whose signal it is looking for. The processor looks at the ethernet frames. Each of the ethernet frames have the basic arrangement as shown in FIG. 3, format 300 has a header 301 of around 48 bytes followed by a body 302, with approximately 1500 bytes of data. Within those 1500 bytes is the format which is shown as a start code 305 followed by a channel for light number 306, followed by data 307. A number of channels can be put into each ethernet data section 302. Therefore, for any given light number, this system looks for the particular channel in the overall data stream at 400. When the system finds the channel, it separates the channel number and data at 405, packages the data as a specified packet, and routes that output to the specified lines at 410. For example, if the channel is channel 1, then the processor will package the data, rebundle it, and send it to channel 1. Effectively, the system continually looks at these contents within the headers, and the overall data stream. This allows the ethernet to simulate an output which is SCSI-like.

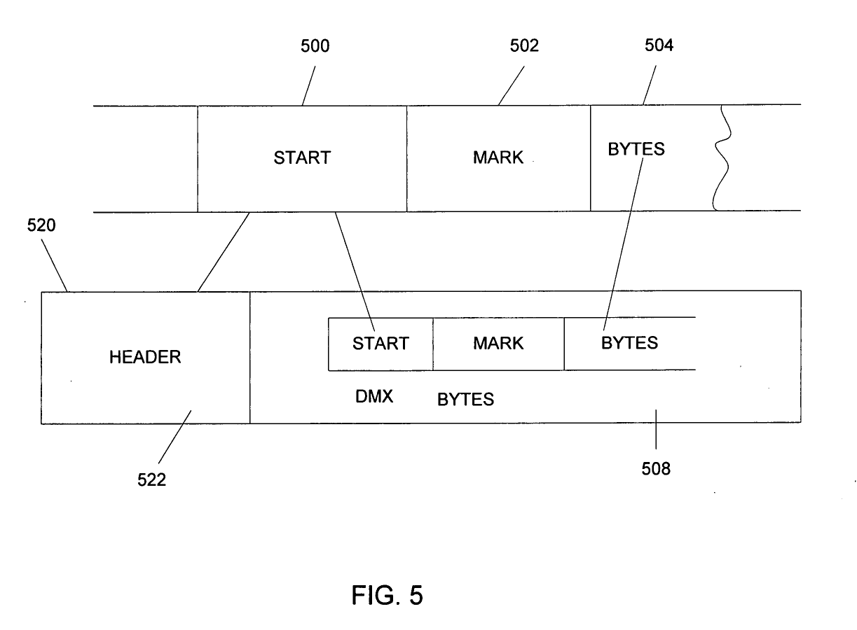

Another embodiment of this system may receive the data via the standard format called DMX 512. In this system, the DMX data is carried over ethernet and handled in a similar way to that discussed above. For example, the standard DMX format is shown in FIG. 5. The DMX format includes a break, shown as the start signal, 500 followed by mark signal 502. This indicates the beginning of the DMX format. This is followed as 504, followed by a specified number of bytes. For example, each channel may include 1 byte of data which controls the state of various dimmers. 512 bytes of information for the dimmers of the 512 channels may therefore follow. The time slot of the information therefore represents the ‘channel’ for which the information is intended. In this system as applied to DMX, the channel information is packaged within an ethernet packet shown as 520, with an ethernet header 522, followed by the data 508 from channel one and similar data from analogous channels. In this embodiment, the data can be output as a single output for each of a plurality of channels, such as 512 channels. Alternatively, the data can be output as standard DMX, where the data output includes all 512 channels time slot multiplexing onto a single line.

In an embodiment, the processor may be either a Radix 3000 processor, or a “rabbit” processor.

Although only a few embodiments have been described in detail alone, other modifications are contemplated.

1. A system, comprising:
an ethernet receiver, receiving a plurality of ethernet packets of ethernet information, collectively representing a plurality of information intended for a plurality of computer-controlled lighting devices, said ethernet information including multiple identification information identifying a specific one of said lighting devices, and data for each said one lighting device; and
a processing element, operating to determine a specified channel within said information, to obtain data associated with said specified channel, and separate said data from said information.

2. A system as in claim 1, further comprising a plurality of output lines, each of said output lines including data for only one of said channels.

3. A system-as in claim 1, wherein each of a plurality of ethernet lines includes data for 10 lighting channels.

4. A system as in claim 1, further comprising a console producing a plurality of ethernet lines.

5. A system as in claim 1, wherein said data in said channel includes data with an identifying designation for the channel, followed by data representing that identifying number.

6. A system as in claim 1, wherein said data in said channel includes data that is in time slot multiplexed format where a position in the packet serves as the identifying information.

7. A system as in claim 1, wherein said data is data for brightness levels of lighting dimmers.

8. A system as in claim 1, further comprising a controlling console, producing control signals for controlling said plurality of computer-controlled lighting devices.

9. A system as in claim 8, wherein said controlling console produces outputs in ethernet format, which outputs are coupled to said ethernet receiver.

10. A system as in claim 1, wherein said processing element produces a plurality of separate outputs, further comprising a plurality of computer-controlled lighting devices, and connections between each separate output and each of said computer-controlled lighting devices.

11. A method as in claim 11, further comprising providing each one of said separate output to a separate lighting device, and using each said separate output to control said separate lighting device.

12. A method as in claim 11, wherein said data is in format with a specified designation, followed by specific data that is related to said specified designation.

13. A method as in claim 11, wherein said data is in a format where an offset from a specified position represents its designation.

14. A method as in claim 11, wherein said data is in a format that simulates SCSI.

15. A method as in claim 11, wherein said data is in a format that simulates DMX 512.

16. A method comprising:
converting an ethernet format which includes data for a plurality of lights that can be controlled via computer, and information indicative of destinations for said plurality of lights, into information to be sent to said plurality of lights, in a native form of said plurality of lights which is not an ethernet format, and producing at least one output in a format for controlling the lights, including data from said ethernet format, as converted into said format for controlling the lights.

17. A method as in claim 18, wherein said format for controlling the lights is DMX 512.

18. A method as in claim 18, wherein said format for controlling the lights includes a single line for each of a plurality of channels, each single line including data for an individual channel.

19. A method as in claim 18, wherein said ethernet format includes designations indicative of a channel number, associated with data for the channel number, and said producing comprises converting said ethernet format into individual channels associated with said data.

20. A method as in claim 18, wherein said ethernet format includes a start indication, and a specified number of lights of information for each of a plurality of channels, so that a position within the format represents the channel number.

21. A method, comprising:
receiving a plurality of ethernet lines with data for a plurality of different computer-controlled lighting devices, each identified by an identifying designation;
identifying one of said identifying designations, within said plurality of ethernet lines; and
separating data for said one of said identifying designations to form separate lines for the separated data.

22. A method as in claim 23, further comprising providing each of the separated data items to separate lines.
